(19) United States
(12) Patent Application Publication
(10) Pub. No.: US 2026/0161645 A1
(43) Pub. Date: Jun. 11, 2026

(54) DATA PROCESSING METHOD, APPARATUS, DEVICE, MEDIUM, AND PRODUCT

(71) Applicant: Beijing Zitiao Network Technology Co., Ltd., Beijing (CN)

(72) Inventors: Qi CHEN, Beijing (CN); Shengqing FANG, Beijing (CN)

(21) Appl. No.: 19/322,463

(22) Filed: Sep. 8, 2025

(30) Foreign Application Priority Data
Dec. 11, 2024 (CN) 202411826240.7

(51) Int. Cl. G06F 16/2453; G06F 16/22; H04L 9/06

(52) U.S. Cl. CPC G06F 16/24534; G06F 16/2282; H04L 9/0618

(57) ABSTRACT

The present application provides a data processing method and apparatus, a device, a medium, and a product. The method includes: obtaining a first database operation statement, where the first database operation statement indicates that a first operation is performed on data in a first plaintext column in a first database; rewriting the first database operation statement to obtain a second database operation statement, where the second database operation statement indicates that the first operation is performed on data in a first ciphertext column in the first database, the first plaintext column stores original data, and the first ciphertext column stores data obtained by encrypting the original data; and executing the second database operation statement to obtain a data processing result.

### CROSS REFERENCE TO RELATED APPLICATIONS

This application is based on and claims priority of CN application with application No. 202411826240.7 filed on Dec. 11, 2024, the entire disclosure of which is incorporated herein by reference.

### TECHNICAL FIELD

The present application relates to the field of computer technologies, and in particular, to a data processing method and apparatus, an electronic device, a computer-readable storage medium, and a computer program product.

### BACKGROUND

With the continuous development of computer technologies, the complexity of services has gradually increased, and service data has gradually increased. Generally, the service data is stored in a database, and in consideration of security issues of the service data, the database usually stores encrypted service data.

### SUMMARY

The present application provides a data processing method in which a data encryption and decryption process is decoupled from a service party, to implement transparent encryption and decryption. The present application further provides an apparatus, an electronic device, a computer-readable storage medium, and a computer program product that correspond to the foregoing method.

According to a first aspect, the present application provides a data processing method. The method includes the following steps.

A first database operation statement is obtained, where the first database operation statement indicates performing a first operation on data in a first plaintext column in a first database.

The first database operation statement is rewritten to obtain a second database operation statement, where the second database operation statement indicates performing the first operation on data in a first ciphertext column in the first database, the first plaintext column stores original data, and the first ciphertext column stores data obtained by encrypting the original data.

The second database operation statement is executed to obtain a data processing result.

In some possible implementations, the step in which the first database operation statement is rewritten to obtain the second database operation statement includes the following steps.

The first database operation statement is parsed to obtain a syntax tree of the first database operation statement.

A first plaintext column that is an operation object in the first database operation statement is determined based on the syntax tree of the first database operation statement.

A first ciphertext column corresponding to the first plaintext column is determined based on a correspondence between plaintext columns and ciphertext columns in the first database.

The first database operation statement is rewritten based on the first ciphertext column to obtain the second database operation statement.

In some possible implementations, the first operation is a query operation, and the step in which the first database operation statement is rewritten based on the first ciphertext column to obtain the second database operation statement includes the following step:
a replace operation or an add operation is performed, based on the first ciphertext column, on a column name of the first plaintext column that is the operation object in the first database operation statement, to obtain the second database operation statement.

In some possible implementations, the first operation is a non-query operation, and the step in which the first database operation statement is rewritten based on the first ciphertext column to obtain the second database operation statement includes the following steps.

First data that is operation data in the first database operation statement is determined.

The first data is encrypted to obtain first encrypted data.

Based on the first ciphertext column and the first encrypted data, an add operation is performed on a column name of the first plaintext column that is the operation object in the first database operation statement, and an add operation is performed on a field name of the first data that is the operation data in the first database operation statement, to obtain the second database operation statement.

In some possible implementations, the method further includes the following step:
an operation state of the first database is obtained, where the operation state represents performing single read or dual read on the first database.

The step in which the replace operation or the add operation is performed, based on the first ciphertext column, on the column name of the first plaintext column that is the operation object in the first database operation statement, to obtain the second database operation statement includes the following steps:
in response to the operation state representing performing single read on the first database, the column name of the first plaintext column that is the operation object in the first database operation statement is replaced with a column name of the first ciphertext column to obtain the second database operation statement; and
in response to the operation state representing performing dual read on the first database, the column name of the first ciphertext column is added to the operation object in the first database operation statement to obtain the second database operation statement.

In some possible implementations, the first operation is the query operation, and the step in which the second database operation statement is executed to obtain the data processing result includes the following steps:
the second database operation statement is executed to obtain a query result; and
the query result is decrypted, and the decrypted query result is returned.

In some possible implementations, the first operation is the non-query operation, and the step in which the second database operation statement is executed to obtain the data processing result includes the following steps:
the second database operation statement is executed to obtain an operation result representing that the data operation is successful or the data operation fails; and
the operation result is returned.

In some possible implementations, the step in which the first database operation statement is rewritten to obtain the second database operation statement includes the following steps:
in response to the presence of a second plaintext column in the first database operation statement, a column name rewrite sub-statement is generated, where the second plaintext column is not the operation object in the first database operation statement, a column name of the second plaintext column is the same as the column name of the first ciphertext column, and the column name rewrite sub-statement indicates rewriting the column name of the first ciphertext column; and
the first database operation statement is rewritten based on the column name rewrite sub-statement to obtain the second database operation statement.

According to a second aspect, the present application provides a data processing apparatus. The apparatus includes an obtaining module, a rewrite module, and an execution module.

The obtaining module is configured to obtain a first database operation statement, where the first database operation statement indicates performing a first operation on data in a first plaintext column in a first database.

The rewrite module is configured to rewrite the first database operation statement to obtain a second database operation statement, where the second database operation statement indicates performing the first operation on data in a first ciphertext column in the first database, the first plaintext column stores original data, and the first ciphertext column stores data obtained by encrypting the original data.

The execution module is configured to execute the second database operation statement to obtain a data processing result.

In some possible implementations, the rewrite module is specifically configured to:
parse the first database operation statement to obtain a syntax tree of the first database operation statement;
determine a first plaintext column that is an operation object in the first database operation statement based on the syntax tree of the first database operation statement;
determine a first ciphertext column corresponding to the first plaintext column based on a correspondence between plaintext columns and ciphertext columns in the first database; and
rewrite the first database operation statement based on the first ciphertext column to obtain the second database operation statement.

In some possible implementations, the first operation is a query operation, and the rewrite module is specifically configured to:
perform, based on the first ciphertext column, a replace operation or an add operation on a column name of the first plaintext column that is the operation object in the first database operation statement, to obtain the second database operation statement.

In some possible implementations, the first operation is a non-query operation, and the rewrite module is specifically configured to:
determine first data that is operation data in the first database operation statement;
encrypt the first data to obtain first encrypted data; and
perform, based on the first ciphertext column and the first encrypted data, an add operation on the column name of the first plaintext column that is the operation object in the first database operation statement, and perform an add operation on a field name of the first data that is the operation data in the first database operation statement, to obtain the second database operation statement.

In some possible implementations, the obtaining module is further configured to:
obtain an operation state of the first database, where the operation state represents performing single read or dual read on the first database.

The rewrite module is specifically configured to:
in response to the operation state representing performing single read on the first database, replace the column name of the first plaintext column that is the operation object in the first database operation statement with a column name of the first ciphertext column to obtain the second database operation statement; and
in response to the operation state representing performing dual read on the first database, add the column name of the first ciphertext column to the operation object in the first database operation statement to obtain the second database operation statement.

In some possible implementations, the first operation is the query operation, and the execution module is specifically configured to:
execute the second database operation statement to obtain a query result; and
decrypt the query result, and return the decrypted query result.

In some possible implementations, the first operation is the non-query operation, and the execution module is further configured to:
execute the second database operation statement to obtain an operation result representing that the data operation is successful or the data operation fails; and
return the operation result.

In some possible implementations, the rewrite module is specifically configured to:
in response to the presence of a second plaintext column in the first database operation statement, generate a column name rewrite sub-statement, where the second plaintext column is not the operation object in the first database operation statement, a column name of the second plaintext column is the same as the column name of the first ciphertext column, and the column name rewrite sub-statement indicates rewriting the column name of the first ciphertext column; and
rewrite the first database operation statement based on the column name rewrite sub-statement to obtain the second database operation statement.

According to a third aspect, the present application provides an electronic device. The electronic device includes a processor and a memory. The processor and the memory communicate with each other. The processor is configured to execute instructions stored in the memory, to enable the electronic device to perform the data processing method according to the first aspect or any one of the implementations of the first aspect.

According to a fourth aspect, the present application provides a computer-readable storage medium. The computer-readable storage medium stores instructions, and the instructions instruct an electronic device to perform the data processing method according to the first aspect or any one of the implementations of the first aspect.

According to a fifth aspect, the present application provides a computer program product that includes instructions. When the computer program product runs on an electronic device, the electronic device is enabled to perform the data processing method according to the first aspect or any one of the implementations of the first aspect.

In the present application, based on the implementations provided in the foregoing aspects, further combination may be performed to provide more implementations.

### BRIEF DESCRIPTION OF THE DRAWINGS

To describe the technical methods in embodiments of the present application more clearly, the following briefly describes the drawings used in describing the embodiments.

FIG. 1 is a schematic flowchart of a data processing method according to an embodiment of the present application;

FIG. 2 is a schematic diagram of interaction in a data processing system according to an embodiment of the present application;

FIG. 3 is a schematic diagram of a structure of a data processing apparatus according to an embodiment of the present application; and

FIG. 4 is a schematic diagram of a structure of an electronic device according to an embodiment of the present application.

### DETAILED DESCRIPTION OF EMBODIMENTS

The terms “first” and “second” in embodiments of the present application are used for descriptive purposes only, and are not to be construed as indicating or implying relative importance or implying a number of indicated technical features. Therefore, a feature defined as “first” or “second” may include one or more of these features explicitly or implicitly.

First, some technical terms and application scenarios involved in embodiments of the present application are described.

A large amount of service data may be generated during a service development, running, and maintenance process. Generally, in consideration of security issues of the service data, some service data may be encrypted and then stored in a database.

Because the database stores encrypted service data, and a service party usually uses unencrypted service data, there is a data encryption and decryption process between the service party and the database. Specifically, the data encryption and decryption process may include the following two processes: a process of encrypting service data provided by the service party and storing the encrypted service data in the database, and a process of decrypting the encrypted service data in the database and returning the decrypted service data to the service party.

Generally, in consideration of stability of service running, the foregoing data encryption and decryption process is implemented by a transparent encryption and decryption technology. The transparent encryption and decryption technology may be understood as that encryption and decryption are automatically performed during a service data transmission process, and the service party does not need to be aware of this process, that is, the service party only needs to provide unencrypted service data when a service is running, the service data is automatically encrypted during a process of transmitting the unencrypted service data to the database, and then the encrypted service data is stored in the database. Similarly, when there is a requirement for operating the service data from the database when the service is running, the service party sends a request for operating the unencrypted service data, the service data is automatically decrypted, and the decrypted service data is returned to the service party. In this way, for the service party, both the service data encryption process and the service data decryption process are transparent, and the service party only needs to operate on the unencrypted service data, without needing to care about how to encrypt or decrypt the service data.

In the related art, the foregoing transparent encryption and decryption process is implemented by executing service code of the service party. In some examples, a software development kit (SDK) is deployed at an application layer of the service party, service traffic between the service party and the database, for example, a database operation statement, is obtained by the SDK, and the database operation statement is modified to implement the data encryption and decryption process. In some other examples, service code for calling a data encryption and decryption application programming interface (API) is added, and the data encryption and decryption process is implemented by calling the data encryption and decryption API.

However, in the foregoing manner in which transparent encryption and decryption are implemented based on the SDK, the SDK deployed at the application layer needs to be adapted to a programming language used by the service party, different service parties need to deploy corresponding SDKs, and development costs are relatively high. When the service is upgraded, the SDK also needs to be upgraded, which is not conducive to service expansion. In the foregoing manner in which transparent encryption and decryption are implemented based on the API, service code of each service party needs to be modified, resulting in certain maintenance costs. In addition, this manner is not conducive to establishing a cross-service data encryption and decryption process, and is poor in applicability.

In the related art, a data encryption and decryption process between a service party and the database is usually implemented by the service party, that is, both a process in which the database stores the encrypted service data and a process in which the service party obtains the decrypted service data are implemented by the service party. However, the foregoing manner is coupled with the service party, and the service party needs to configure corresponding service code for the data encryption and decryption process, resulting in high development costs and low applicability.

In view of this, the present application provides a data processing method. In the method, a first database operation statement is first obtained, where the first database operation statement indicates performing a first operation on data in a first plaintext column in a first database; then, the first database operation statement is rewritten to obtain a second database operation statement, where the second database operation statement indicates performing the first operation on data in a first ciphertext column in the first database, the first plaintext column stores original data, and the first ciphertext column stores data obtained by encrypting the original data; and the second database operation statement is executed to obtain a data processing result.

In the method, the first database operation statement sent by a service party is used to operate on data in the plaintext column in the database, and the first database operation statement is rewritten to operate on data in the corresponding ciphertext column in the database. In this way, for the service party, operations are all performed on plaintext data in the database, and the service party does not need to be aware of the data encryption and decryption process, and does not need to configure service code related to data encryption and decryption. The data encryption and decryption process is decoupled from the service party, to implement transparent encryption and decryption, which is widely applicable to various service parties.

It may be learned from the foregoing technical solutions that the present application has the following advantages.

The present application provides a data processing method. In the method, a first database operation statement is first obtained, where the first database operation statement indicates performing a first operation on data in a first plaintext column in a first database; then, the first database operation statement is rewritten to obtain a second database operation statement, where the second database operation statement indicates performing the first operation on data in a first ciphertext column in the first database, the first plaintext column stores original data, and the first ciphertext column stores data obtained by encrypting the original data; and the second database operation statement is executed to obtain a data processing result.

In the method, the first database operation statement sent by a service party is used to operate on data in the plaintext column in the database, and the first database operation statement is rewritten to operate on data in the corresponding ciphertext column in the database. In this way, for the service party, operations are all performed on plaintext data in the database, and the service party does not need to be aware of the data encryption and decryption process, and does not need to configure service code related to data encryption and decryption. The data encryption and decryption process is decoupled from the service party, to implement transparent encryption and decryption, which is widely applicable to various service parties.

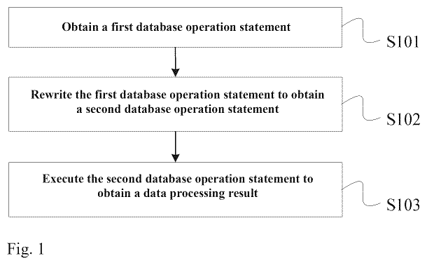

To better understand the technical solutions provided in embodiments of the present application, the following describes with reference to the drawings. FIG. 1 is a schematic flowchart of a data processing method. The method specifically includes the following steps.

S101: obtaining a first database operation statement.

The first database operation statement may be understood as a statement used to operate on data in the database. For example, the first database operation statement may be a structured query language (SQL) statement.

In this embodiment of the present application, the first database operation statement may be sent by a service party, and the first database operation statement may indicate performing a first operation on data in a first plaintext column in a first database. The first database may be a relational database associated with the service party. In other words, the first database may be understood as a database used to store service data of the service party.

The first database may include a plurality of data tables, and each data table stores service data in a table form. Specifically, the data table includes rows and columns. Generally, one column of the data table corresponds to one field, and one row of the data table corresponds to one piece of service data. For example, one piece of service data includes an account identity (ID) and an account nickname, a first column of the data table may correspond to an account ID field, and this column may store account IDs of different accounts; and a second column of the data table may correspond to an account nickname field, and this column may store account nicknames of different accounts. In addition, the first column and the second column of the same row store data of the same account.

In consideration of the fact that there may be a relatively critical field in the service data, to ensure security of the service data, the first database may include a plaintext column and a ciphertext column. The plaintext column may be understood as a column used to store unencrypted service data, and the ciphertext column may be understood as a column used to store encrypted service data. In this embodiment of the present application, for the same field in the service data, the first database stores both unencrypted service data and encrypted service data, that is, the first database includes a plaintext column and a ciphertext column that have a correspondence, and the plaintext column and the ciphertext column that have the correspondence respectively store plaintext data and ciphertext data of the same piece of service data.

The service party may perform different types of first operations on the data in the first database, that is, the first operation may be understood as any operation performed on the data in the first database. For example, the first operation may be a query operation, an insert operation, an update operation, a delete operation, or the like.

For the service party, the service data that the service party contacts is only unencrypted, and the service party does not know how the service data is encrypted and then stored in the first database. Therefore, when the service party has a requirement to operate on the data in the first database, the sent first database operation statement is used to operate on plaintext data (that is, the data in the first plaintext column) in the first database.

S102: rewriting the first database operation statement to obtain a second database operation statement.

In this embodiment of the present application, in consideration of transmission security and storage security of the service data, in an actual process of accessing the first database, an operation is performed on ciphertext data in the first database. Therefore, the first database operation statement needs to be rewritten to obtain a rewritten second database operation statement.

The second database operation statement may indicate performing the first operation on data in a first ciphertext column in the first database, the first plaintext column stores original data, and the first ciphertext column stores data obtained by encrypting the original data. That is, the first plaintext column and the first ciphertext column have a correspondence, and the first plaintext column and the first ciphertext column store the same original data, the first plaintext column stores plaintext data of the original data, and the first ciphertext column stores ciphertext data of the original data.

The first database operation statement is rewritten so that, compared with the first database operation statement, the rewritten second database operation statement performs the same first operation, but the second database operation statement operates on the data in the first ciphertext column.

During specific implementation, the first database operation statement is parsed to obtain a syntax tree of the first database operation statement, a first plaintext column that is an operation object in the first database operation statement is determined based on the syntax tree of the first database operation statement, a first ciphertext column corresponding to the first plaintext column is determined based on a correspondence between plaintext columns and ciphertext columns in the first database, and the first database operation statement is rewritten based on the first ciphertext column to obtain the second database operation statement.

The syntax tree (which may also be referred to as a parse tree) of the first database operation statement may be understood as a tree model used to represent a statement structure of the first database operation statement, and the syntax tree describes a syntax and semantic structure of the first database operation statement.

In this embodiment of the present application, there is no limitation on a manner of obtaining the syntax tree of the first database operation statement. For example, the first database operation statement may be decomposed into a plurality of tokens, and the plurality of tokens are combined into the syntax tree from top to bottom or from bottom to top based on a syntax rule of the first database operation statement.

An object may be understood as a column corresponding to a field included in the database operation statement, and the operation object may be understood as an object returned after the database operation statement is executed. For example, when some data of a field A is returned after the database operation statement is executed, the operation object may be a column corresponding to the field A. A plurality of objects may exist in the first database operation statement, but the plurality of objects are not necessarily all operation objects. Therefore, in this embodiment of the present application, the syntax tree of the first database operation statement is analyzed to determine the first plaintext column that is the operation object in the first database operation statement.

For example, a database operation statement is “SELECT name FROM customers WHERE age>30”, where objects include name and age, and an object returned after the database operation statement is executed is name. Therefore, the operation object is a name column.

The first plaintext column that is the operation object in the first database operation statement is determined, and thus the first ciphertext column corresponding to the first plaintext column may be further determined based on the correspondence between the plaintext columns and the ciphertext columns. In this way, the first database operation statement is rewritten in combination with the first ciphertext column.

In this embodiment of the present application, different operation types of the first operation may have different rewrite logics. In some embodiments, the first operation is a query operation. In this case, a replace operation or an add operation is performed, based on the first ciphertext column, on a column name of the first plaintext column that is the operation object in the first database operation statement, to obtain the second database operation statement.

The query operation may be understood as an operation of querying data from the first database. In other words, the first database operation statement itself does not carry data, and data is carried in a returned query result after the query operation is performed. In this case, the column name of the first plaintext column that is the operation object is rewritten, the column name of the first plaintext column is replaced with a column name of the first ciphertext column, or the first ciphertext column is added as an operation object based on the first database operation statement, to implement a logic of querying data from the first ciphertext column in the first database.

In the foregoing rewrite logic, the replace operation or the add operation is incorporated to account for different operation states of the first database. Specifically, an operation state of the first database is obtained, and the operation state may represent performing single read or dual read on the first database. In response to the operation state representing performing single read on the first database, the column name of the first plaintext column that is the operation object in the first database operation statement is replaced with the column name of the first ciphertext column to obtain the second database operation statement. Similarly, in response to the operation state representing performing dual read on the first database, the column name of the first ciphertext column is added to the operation object in the first database operation statement to obtain the second database operation statement.

The single read may be understood as that only ciphertext data is read from the database, that is, the returned query result includes only ciphertext data. The dual read may be understood as that plaintext data and ciphertext data are simultaneously read from the database, that is, the returned query result includes plaintext data and ciphertext data. Generally, the dual read is used in a gray scale test stage, and the plaintext data is used as backup data by simultaneously reading the plaintext data and the ciphertext data. In an actual service running process, the single read is usually used.

In this way, when the operation state is the single read, because only the ciphertext data needs to be read, the column name of the first plaintext column is replaced with the column name of the first ciphertext column, so that the second database operation statement has a logic of “reading data from the first ciphertext column”. When the operation state is the dual read, because the plaintext data and the ciphertext data need to be simultaneously read, the column name of the first ciphertext column is added based on the column name of the first plaintext column that is the operation object, so that the second database operation statement has a logic of “reading data from the first plaintext column and the first ciphertext column”.

For example, the first database operation statement is “SELECT Name FROM t”, the first plaintext column that is the operation object in the first database operation statement is a Name column, and the first ciphertext column that have the correspondence to the first plaintext column is a _Name column. When the operation state is the single read, the first database operation statement is rewritten to obtain the second database operation statement “SELECT _Name FROM t”, to query ciphertext data of the _Name column from the data table t. When the operation state is the dual read, the first database operation statement is rewritten to obtain the second database operation statement “SELECT Name, _Name FROM t”, to simultaneously query plaintext data of the Name column and ciphertext data of the _Name column from the data table t.

In some other embodiments, the first operation is a non-query operation. In this case, first data that is operation data in the first database operation statement is determined, the first data is encrypted to obtain first encrypted data, and based on the first ciphertext column and the first encrypted data, an add operation is performed on the column name of the first plaintext column that is the operation object in the first database operation statement, and an add operation is performed on a field name of the first data that is the operation data in the first database operation statement, to obtain the second database operation statement.

The non-query operation may be understood as a modification operation performed on specified data, and the specified data is the operation data, for example, an insert operation of inserting the specified data into the database, a delete operation of deleting the specified data from the database, an update operation of updating original data in the database with the specified data, and the like. In other words, the first database operation statement itself carries data, and in this embodiment of the present application, the specified data for the non-query operation is referred to as the first data. In this case, both the column name of the first plaintext column that is the operation object and the first data that is the operation data are rewritten, the first ciphertext column is added as an operation object based on the first database operation statement, and the first encrypted data is added as operation data, to implement a logic of simultaneously modifying the first plaintext column and the first ciphertext column.

For example, the first database operation statement is “INSERT INTO t (Name) VALUES (‘plain_name’)”, the first plaintext column that is the operation object in the first database operation statement is the Name column, the first ciphertext column that have the correspondence the first plaintext column is the _Name column, the first data that is the operation data in the first database operation statement is ‘plain_name’, and the first encrypted data obtained after the first data is encrypted is ‘cipher_name’. The first database operation statement is rewritten to obtain the second database operation statement “INSERT INTO t (Name, _Name) VALUES (‘plain_name’, ‘cipher_name’)”, plaintext data ‘plain_name’ is inserted into the Name column of the data table t, and at the same time, ciphertext data ‘cipher_name’ is inserted into the _Name column of the data table t.

In some possible implementations, an object in the first database operation statement may conflict with the column name of the first ciphertext column. In response to the presence of a second plaintext column in the first database operation statement, a column name rewrite sub-statement is generated, and the first database operation statement is rewritten based on the column name rewrite sub-statement to obtain the second database operation statement.

The second plaintext column is not the operation object in the first database operation statement, a column name of the second plaintext column is the same as the column name of the first ciphertext column, and the column name rewrite sub-statement indicates rewriting the column name of the first ciphertext column. That is, the second plaintext column that has the same column name as the column name of the first ciphertext column exists in the first database operation statement. For example, the first database operation statement is “SELECT Name FROM (SELECT Name, Age AS _Name FROM t)”, the first plaintext column that is the operation object in the first database operation statement is a Name column, the first ciphertext column that have the correspondence the first plaintext column is a _Name column, and meanwhile, a second plaintext column, namely, the _Name column, also exists in the first database operation statement, causing a naming conflict with the first ciphertext column.

In this case, to ensure smooth execution of the second database operation statement, naming replacement needs to be performed. Continuing with the above example, when the operation state is the single read, the second database operation statement is “SELECT Name FROM (SELECT _Name AS Name, Age AS _Name FROM t)”, where the column name rewrite sub-statement is “_Name AS Name”. When the operation state is the dual read, the second database operation statement is “SELECT Name, _Name_0 FROM (SELECT Name, Age AS _Name, _Name as _Name_0 FROM t)”, where the column name rewrite sub-statement is “_Name as _Name_0”. In this way, in the case of a naming conflict, the column name rewrite sub-statement is used so that there is no case where the first ciphertext column has the same column name as another object in the rewritten second database operation statement, ensuring smooth execution of the second database operation statement.

S103: executing the second database operation statement to obtain a data processing result.

After the database operation statement is rewritten, the second database operation statement may indicate performing an operation on the ciphertext data in the first database. Therefore, the second database operation statement is executed, and in an actual process of accessing the first database, the operation is performed on the ciphertext data in the first database, to ensure transmission security and storage security of the service data.

Similarly, different operation types of the first operation may obtain different data processing results. In some embodiments, the first operation is the query operation. In this case, the second database operation statement is executed to obtain a query result, the query result is decrypted, and the decrypted query result is returned.

When the first operation is the query operation, the second database operation statement is executed, and the returned query result carries ciphertext data read from the first database. Therefore, the query result needs to be decrypted, and corresponding plaintext data needs to be returned to the service party. In this way, the service party sends the first database operation statement indicating to query the plaintext data, and receives the query result including the plaintext data, without being aware of the data encryption and decryption process.

In some other embodiments, the first operation is the non-query operation. In this case, the second database operation statement is executed to obtain an operation result representing that the data operation is successful or the data operation fails, and the operation result is returned.

When the first operation is the non-query operation, the second database operation statement is executed, and the returned operation result does not carry data in the first database, and only represents whether the operation is successful. Therefore, there is no need to decrypt the operation result, and the operation result is directly returned to the service party. In this way, the service party sends the first database operation statement indicating to perform the non-query operation on the plaintext data, receives the operation result, without being aware of the data encryption and decryption process.

In the method, the first database operation statement sent by the service party is used to operate on data in the plaintext column in the database, and the first database operation statement is rewritten to operate on data in the corresponding ciphertext column in the database. In this way, for the service party, operations are all performed on plaintext data in the database, and the service party does not need to be aware of the data encryption and decryption process, and does not need to configure service code related to data encryption and decryption. The data encryption and decryption process is decoupled from the service party, to implement transparent encryption and decryption, which is widely applicable to various service parties.

The foregoing data processing method may be performed by a data processing system, and in this embodiment of the present application, the data processing system may be provided as a component. In other words, the data processing system may be connected, as a component, to service logic of the service party, to implement transparent encryption and decryption without modifying original service logic of the service party. In addition, subsequently, only the component, namely, the data processing system, may be updated and upgraded without affecting other service logic of the service party.

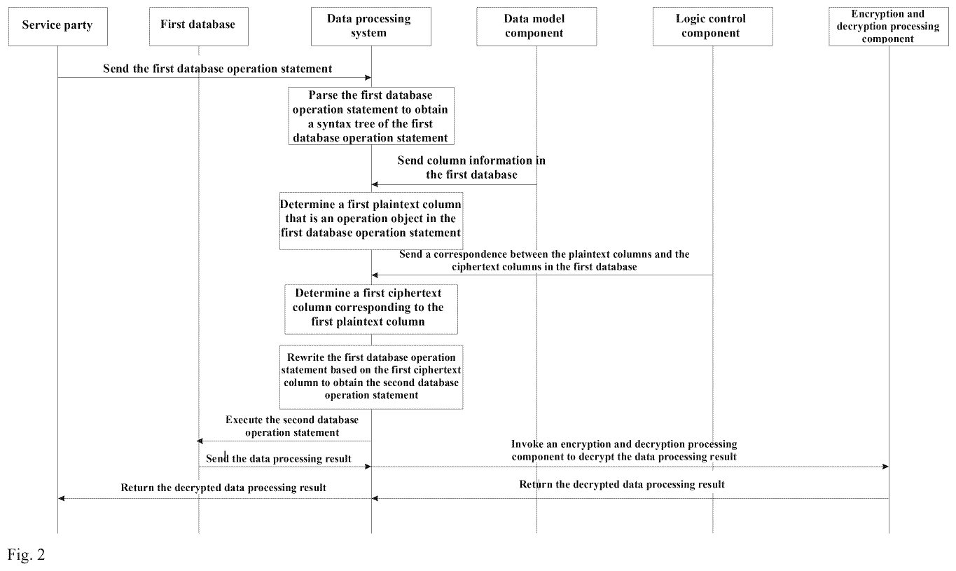

The data processing system may implement the foregoing data processing method together with another component. As shown in FIG. 2, the service party sends the first database operation statement to the data processing system, and the data processing system parses the first database operation statement to obtain a syntax tree of the first database operation statement. Then, a data model component sends column information in the first database to the data processing system, for example, information about whether each column in the first database is a plaintext column or a ciphertext column, and information about an encryption algorithm for each ciphertext column in the first database. The data processing system determines, based on the column information in the first database, from the syntax tree of the first database operation statement, the first plaintext column that is the operation object and that has a corresponding ciphertext column.

Then, a logic control component sends a correspondence between the plaintext columns and the ciphertext columns in the first database to the data processing system. The data processing system determines the first ciphertext column corresponding to the first plaintext column based on the correspondence between the plaintext columns and the ciphertext columns in the first database, and rewrites the first database operation statement based on the first ciphertext column to obtain the second database operation statement.

The data processing system executes the second database operation statement in the first database to obtain the data processing result sent by the first database. When the first operation is the query operation, the data processing result is the query result including the ciphertext data. The data processing system invokes an encryption and decryption processing component to decrypt the data processing result, obtains a decrypted data processing result returned by the encryption and decryption processing component, and returns the decrypted data processing result to the service party. In this way, the service party does not need to modify service code, and does not need to rewrite the database operation statement. By connecting to the data processing system, the service party may implement data processing and transparent data encryption and decryption based on sending the first database operation statement and being unaware of the data encryption and decryption process.

The data processing method provided in this embodiment of the present application is described in detail above with reference to FIG. 1 and FIG. 2. An apparatus and a device provided in embodiments of the present application are described below with reference to the drawings.

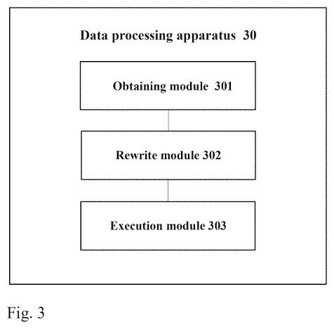

FIG. 3 is a schematic diagram of a structure of a data processing apparatus. The apparatus 30 includes an obtaining module 301, a rewrite module 302, and an execution module 303.

The obtaining module 301 is configured to obtain a first database operation statement, where the first database operation statement indicates performing a first operation on data in a first plaintext column in a first database.

The rewrite module 302 is configured to rewrite the first database operation statement to obtain a second database operation statement, where the second database operation statement indicates performing the first operation on data in a first ciphertext column in the first database, the first plaintext column stores original data, and the first ciphertext column stores data obtained by encrypting the original data.

The execution module 303 is configured to execute the second database operation statement to obtain a data processing result.

In some possible implementations, the rewrite module 302 is specifically configured to:
parse the first database operation statement to obtain a syntax tree of the first database operation statement;
determine a first plaintext column that is an operation object in the first database operation statement based on the syntax tree of the first database operation statement;
determine a first ciphertext column corresponding to the first plaintext column based on a correspondence between plaintext columns and ciphertext columns in the first database; and
rewrite the first database operation statement based on the first ciphertext column to obtain the second database operation statement.

In some possible implementations, the first operation is a query operation, and the rewrite module 302 is specifically configured to:
perform, based on the first ciphertext column, a replace operation or an add operation on a column name of the first plaintext column that is the operation object in the first database operation statement, to obtain the second database operation statement.

In some possible implementations, the first operation is a non-query operation, and the rewrite module 302 is specifically configured to:
determine first data that is operation data in the first database operation statement;
encrypt the first data to obtain first encrypted data; and
perform, based on the first ciphertext column and the first encrypted data, an add operation on the column name of the first plaintext column that is the operation object in the first database operation statement, and perform an add operation on a field name of the first data that is the operation data in the first database operation statement, to obtain the second database operation statement.

In some possible implementations, the obtaining module 301 is further configured to:
obtain an operation state of the first database, where the operation state represents performing single read or dual read on the first database.

The rewrite module 302 is specifically configured to:
in response to the operation state representing performing single read on the first database, replace the column name of the first plaintext column that is the operation object in the first database operation statement with a column name of the first ciphertext column to obtain the second database operation statement; and
in response to the operation state representing performing dual read on the first database, add the column name of the first ciphertext column to the operation object in the first database operation statement to obtain the second database operation statement.

In some possible implementations, the first operation is the query operation, and the execution module 303 is further configured to:
execute the second database operation statement to obtain a query result; and
decrypt the query result, and return the decrypted query result.

In some possible implementations, the first operation is the non-query operation, and the execution module 303 is specifically configured to:
execute the second database operation statement to obtain an operation result representing that the data operation is successful or the data operation fails; and
return the operation result.

In some possible implementations, the rewrite module 302 is specifically configured to:
in response to the presence of a second plaintext column in the first database operation statement, generate a column name rewrite sub-statement, where the second plaintext column is not the operation object in the first database operation statement, a column name of the second plaintext column is the same as the column name of the first ciphertext column, and the column name rewrite sub-statement indicates rewriting the column name of the first ciphertext column; and
rewrite the first database operation statement based on the column name rewrite sub-statement to obtain the second database operation statement.

The data processing apparatus 30 according to an embodiment of the present application may correspond to performing the method described in an embodiment of the present application, and the foregoing and other operations and/or functions of the modules/units of the data processing apparatus 30 are respectively intended to implement corresponding procedures of the various methods in the embodiment shown in FIG. 1. For the sake of simplicity, details are not described herein again.

An embodiment of the present application further provides an electronic device. The electronic device is further configured to implement the function of the data processing apparatus 30 in the embodiment shown in FIG. 3.

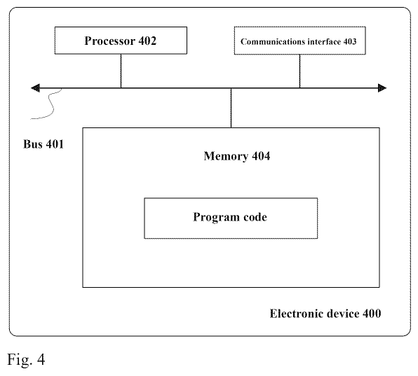

FIG. 4 is a schematic diagram of a structure of an electronic device 400. As shown in FIG. 4, the electronic device 400 includes a bus 401, a processor 402, a communications interface 403, and a memory 404. The processor 402, the memory 404, and the communications interface 403 communicate with each other through the bus 401.

The bus 401 may be a peripheral component interconnect (PCI) bus, an extended industry standard architecture (EISA) bus, or the like. The bus may be classified into an address bus, a data bus, a control bus, and the like. For ease of representation, FIG. 4 shows only one bold line, but does not represent that there is only one bus or one type of bus.

The processor 402 may be any one or more of a central processing unit (CPU), a graphics processing unit (GPU), a microprocessor (MP), a digital signal processor (DSP), or the like.

The communications interface 403 is configured for external communication. For example, the communications interface 403 may be configured to communicate with a terminal.

The memory 404 may include a volatile memory, for example, a random access memory (RAM). The memory 404 may further include a non-volatile memory, for example, a read-only memory (ROM), a flash memory, a hard disk drive (HDD), or a solid state drive (SSD).

The memory 404 stores executable code, and the processor 402 executes the executable code to perform the foregoing data processing method.

Specifically, in the case of implementing the embodiment shown in FIG. 3, and when the modules or units of the data processing apparatus 30 described in the embodiment in FIG. 3 are implemented by software, software or program code required to perform functions of the modules/units in FIG. 3 may be partially or entirely stored in the memory 404. The processor 402 executes program code corresponding to the units stored in the memory 404, to perform the foregoing data processing method.

An embodiment of the present application further provides a computer-readable storage medium. The computer-readable storage medium may be any usable medium that may be stored by a computing device, or a data storage device, such as a data center, that includes one or more usable media. The usable medium may be a magnetic medium (for example, a floppy disk, a hard disk, or a magnetic tape), an optical medium (for example, a DVD), a semiconductor medium (for example, a solid state disk), or the like. The computer-readable storage medium includes instructions, and the instructions instruct a computing device to perform the foregoing data processing method applied to the data processing apparatus 30.

An embodiment of the present application further provides a computer program product. The computer program product includes one or more computer instructions. When the computer instructions are loaded and executed on a computing device, the procedure or functions according to the embodiments of the present application are all or partially generated.

The computer instructions may be stored in a computer-readable storage medium, or may be transmitted from one computer-readable storage medium to another computer-readable storage medium. For example, the computer instructions may be transmitted from one website, computer, or data center to another website, computer, or data center in a wired (for example, a coaxial cable, an optical fiber, or a digital subscriber line (DSL)) or wireless (for example, infrared, radio, or microwave) manner.

When the computer program product is executed by a computer, the computer performs any one of the foregoing data processing methods. The computer program product may be a software installation package. When any one of the foregoing data processing methods needs to be used, the computer program product may be downloaded and executed on a computer.

The flowcharts and block diagrams in the drawings illustrate the possibly implemented architectures, functions, and operations of the system, the method, and the computer program product according to the embodiments of the present application. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments described in the present application may be implemented by software or by hardware. The name of a unit/module does not constitute a limitation on the unit itself in some cases.

The functions described above may be performed at least partially by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logical device (CPLD), etc.

In the context of the embodiments of the present application, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

It should be noted that the embodiments in this specification are described in a progressive manner. Each embodiment focuses on differences from other embodiments, and the same or similar parts between the embodiments may be referred to each other. For a system or an apparatus disclosed in an embodiment, because it corresponds to the method disclosed in the embodiment, the description is relatively simple, and for related parts, reference may be made to the description of the method.

It should be understood that in the present application, “at least one (item)” means one or more, and “a plurality of” means two or more. The term “and/or” describes an association relationship between associated objects, and represents that three relationships may exist. For example, “A and/or B” may represent the following three cases: Only A exists, only B exists, and both A and B exist, where A and B may be singular or plural. The character “/” generally indicates an “or” relationship between the associated objects. At least one of the following items (pieces)” or a similar expression thereof indicates any combination of these items, including a single item (piece) or any combination of a plurality of items (pieces). For example, at least one of a, b, or c may represent: a, b, c, “a and b”, “a and c”, “b and c”, or “a, b, and c”, where a, b, and c may be singular or plural.

It should also be noted that in this specification, relational terms such as first and second are used only to distinguish one entity or operation from another entity or operation, and do not necessarily require or imply any actual relationship or order between these entities or operations. Moreover, the terms “include”, “comprise”, or any other variant thereof are intended to cover non-exclusive inclusion, so that a process, method, object, or device that includes a list of elements includes not only those elements, but also other elements not explicitly listed or elements inherent to such a process, method, object, or device. Without further restrictions, an element defined by the phrase “includes a” does not exclude the existence of other identical elements in the process, method, object, or device that includes the element.

Steps of a method or an algorithm described in conjunction with the embodiments disclosed herein may be directly implemented by hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or a storage medium of any other form known in the art.

The foregoing description of the disclosed embodiments enables those skilled in the art to implement or use the present application. Various modifications to these embodiments will be apparent to those skilled in the art, and the generic principles defined herein may be implemented in other embodiments without departing from the spirit or scope of the present application. Therefore, the present application is not to be limited to the embodiments shown herein, but is to be accorded the widest scope consistent with the principles and novel features disclosed herein.

1. A data processing method, wherein the method comprises:
obtaining a first database operation statement, wherein the first database operation statement indicates performing a first operation on data in a first plaintext column in a first database;
rewriting the first database operation statement to obtain a second database operation statement, wherein the second database operation statement indicates performing the first operation on data in a first ciphertext column in the first database, the first plaintext column stores original data, and the first ciphertext column stores data obtained by encrypting the original data; and
executing the second database operation statement to obtain a data processing result.

2. The method of claim 1, wherein the rewriting the first database operation statement to obtain a second database operation statement comprises:
parsing the first database operation statement to obtain a syntax tree of the first database operation statement;
determining a first plaintext column that is an operation object in the first database operation statement based on the syntax tree of the first database operation statement;
determining a first ciphertext column corresponding to the first plaintext column based on a correspondence between plaintext columns and ciphertext columns in the first database; and
rewriting the first database operation statement based on the first ciphertext column to obtain the second database operation statement.

3. The method of claim 2, wherein the first operation is a query operation, and the rewriting the first database operation statement based on the first ciphertext column to obtain the second database operation statement comprises:
performing, based on the first ciphertext column, a replace operation or an add operation on a column name of the first plaintext column that is the operation object in the first database operation statement, to obtain the second database operation statement.

4. The method of claim 2, wherein the first operation is a non-query operation, and the rewriting the first database operation statement based on the first ciphertext column to obtain the second database operation statement comprises:
determining first data that is operation data in the first database operation statement;
encrypting the first data to obtain first encrypted data; and
performing, based on the first ciphertext column and the first encrypted data, an add operation on a column name of the first plaintext column that is the operation object in the first database operation statement, and performing an add operation on a field name of the first data that is the operation data in the first database operation statement, to obtain the second database operation statement.

5. The method of claim 3, wherein the method further comprises:
obtaining an operation state of the first database, wherein the operation state represents performing single read or dual read on the first database; and
the performing, based on the first ciphertext column, a replace operation or an add operation on the column name of the first plaintext column that is the operation object in the first database operation statement, to obtain the second database operation statement comprises:
in response to the operation state representing performing single read on the first database, replacing the column name of the first plaintext column that is the operation object in the first database operation statement with a column name of the first ciphertext column to obtain the second database operation statement; and
in response to the operation state representing performing dual read on the first database, adding the column name of the first ciphertext column to the operation object in the first database operation statement to obtain the second database operation statement.

6. The method of claim 1, wherein the first operation is a query operation, and the executing the second database operation statement to obtain a data processing result comprises:
executing the second database operation statement to obtain a query result; and
decrypting the query result, and returning the decrypted query result.

7. The method of claim 1, wherein the first operation is a non-query operation, and the executing the second database operation statement to obtain a data processing result comprises:
executing the second database operation statement to obtain an operation result representing that the data operation is successful or the data operation fails; and
returning the operation result.

8. The method of claim 1, wherein the rewriting the first database operation statement to obtain a second database operation statement comprises:
in response to the presence of a second plaintext column in the first database operation statement, generating a column name rewrite sub-statement, wherein the second plaintext column is not the operation object in the first database operation statement, a column name of the second plaintext column is the same as the column name of the first ciphertext column, and the column name rewrite sub-statement indicates rewriting the column name of the first ciphertext column; and
rewriting the first database operation statement based on the column name rewrite sub-statement to obtain the second database operation statement.

9. An electronic device, wherein the electronic device comprises a processor and a memory; and
the processor is configured to execute instructions stored in the memory, to enable the electronic device to perform a data processing method, the method comprises:
obtaining a first database operation statement, wherein the first database operation statement indicates performing a first operation on data in a first plaintext column in a first database;
rewriting the first database operation statement to obtain a second database operation statement, wherein the second database operation statement indicates performing the first operation on data in a first ciphertext column in the first database, the first plaintext column stores original data, and the first ciphertext column stores data obtained by encrypting the original data; and
executing the second database operation statement to obtain a data processing result.

10. The electronic device of claim 9, wherein the rewriting the first database operation statement to obtain a second database operation statement comprises:
parsing the first database operation statement to obtain a syntax tree of the first database operation statement;
determining a first plaintext column that is an operation object in the first database operation statement based on the syntax tree of the first database operation statement;
determining a first ciphertext column corresponding to the first plaintext column based on a correspondence between plaintext columns and ciphertext columns in the first database; and
rewriting the first database operation statement based on the first ciphertext column to obtain the second database operation statement.

11. The electronic device of claim 10, wherein the first operation is a query operation, and the rewriting the first database operation statement based on the first ciphertext column to obtain the second database operation statement comprises:
performing, based on the first ciphertext column, a replace operation or an add operation on a column name of the first plaintext column that is the operation object in the first database operation statement, to obtain the second database operation statement.

12. The electronic device of claim 10, wherein the first operation is a non-query operation, and the rewriting the first database operation statement based on the first ciphertext column to obtain the second database operation statement comprises:
determining first data that is operation data in the first database operation statement;
encrypting the first data to obtain first encrypted data; and
performing, based on the first ciphertext column and the first encrypted data, an add operation on a column name of the first plaintext column that is the operation object in the first database operation statement, and performing an add operation on a field name of the first data that is the operation data in the first database operation statement, to obtain the second database operation statement.

13. The electronic device of claim 11, wherein the method further comprises:
obtaining an operation state of the first database, wherein the operation state represents performing single read or dual read on the first database; and
the performing, based on the first ciphertext column, a replace operation or an add operation on the column name of the first plaintext column that is the operation object in the first database operation statement, to obtain the second database operation statement comprises:
in response to the operation state representing performing single read on the first database, replacing the column name of the first plaintext column that is the operation object in the first database operation statement with a column name of the first ciphertext column to obtain the second database operation statement; and
in response to the operation state representing performing dual read on the first database, adding the column name of the first ciphertext column to the operation object in the first database operation statement to obtain the second database operation statement.

14. The electronic device of claim 9, wherein the first operation is a query operation, and the executing the second database operation statement to obtain a data processing result comprises:
executing the second database operation statement to obtain a query result; and
decrypting the query result, and returning the decrypted query result.

15. A non-transitory computer-readable storage medium, characterized by comprising instructions that, when executed, instruct an electronic device to perform a data processing method, the method comprises:
obtaining a first database operation statement, wherein the first database operation statement indicates performing a first operation on data in a first plaintext column in a first database;
rewriting the first database operation statement to obtain a second database operation statement, wherein the second database operation statement indicates performing the first operation on data in a first ciphertext column in the first database, the first plaintext column stores original data, and the first ciphertext column stores data obtained by encrypting the original data; and
executing the second database operation statement to obtain a data processing result.

16. The non-transitory computer-readable storage medium of claim 15, wherein the rewriting the first database operation statement to obtain a second database operation statement comprises:
parsing the first database operation statement to obtain a syntax tree of the first database operation statement;
determining a first plaintext column that is an operation object in the first database operation statement based on the syntax tree of the first database operation statement;
determining a first ciphertext column corresponding to the first plaintext column based on a correspondence between plaintext columns and ciphertext columns in the first database; and
rewriting the first database operation statement based on the first ciphertext column to obtain the second database operation statement.

17. The non-transitory computer-readable storage medium of claim 16, wherein the first operation is a query operation, and the rewriting the first database operation statement based on the first ciphertext column to obtain the second database operation statement comprises:
performing, based on the first ciphertext column, a replace operation or an add operation on a column name of the first plaintext column that is the operation object in the first database operation statement, to obtain the second database operation statement.

18. The non-transitory computer-readable storage medium of claim 16, wherein the first operation is a non-query operation, and the rewriting the first database operation statement based on the first ciphertext column to obtain the second database operation statement comprises:
determining first data that is operation data in the first database operation statement;
encrypting the first data to obtain first encrypted data; and
performing, based on the first ciphertext column and the first encrypted data, an add operation on a column name of the first plaintext column that is the operation object in the first database operation statement, and performing an add operation on a field name of the first data that is the operation data in the first database operation statement, to obtain the second database operation statement.

19. The non-transitory computer-readable storage medium of claim 17, wherein the method further comprises:
obtaining an operation state of the first database, wherein the operation state represents performing single read or dual read on the first database; and
the performing, based on the first ciphertext column, a replace operation or an add operation on the column name of the first plaintext column that is the operation object in the first database operation statement, to obtain the second database operation statement comprises:
in response to the operation state representing performing single read on the first database, replacing the column name of the first plaintext column that is the operation object in the first database operation statement with a column name of the first ciphertext column to obtain the second database operation statement; and
in response to the operation state representing performing dual read on the first database, adding the column name of the first ciphertext column to the operation object in the first database operation statement to obtain the second database operation statement.

20. The non-transitory computer-readable storage medium of claim 15, wherein the first operation is a query operation, and the executing the second database operation statement to obtain a data processing result comprises:
executing the second database operation statement to obtain a query result; and
decrypting the query result, and returning the decrypted query result.
